(19) United States
(12) Patent Application Publication
(10) Pub. No.: US 2017/0091318 A1
(43) Pub. Date: Mar. 30, 2017

(54) APPARATUS AND METHOD FOR EXTRACTING KEYWORDS FROM A SINGLE DOCUMENT

(71) Applicant: Kabushiki Kaisha Toshiba, Minato-ku (JP)

(72) Inventors: Zhengshan XUE, Beijing (CN); Dakun ZHANG, Beijing (CN); Jichong GUO, Beijing (CN); Jie HAO, Beijing (CN)

(73) Assignee: Kabushiki Kaisha Toshiba, Minato-ku (JP)

(21) Appl. No.: 15/247,396

(22) Filed: Aug. 25, 2016

(30) Foreign Application Priority Data
Sep. 29, 2015 (CN) 201510632825.X

(51) Int. Cl. G06F 17/30

(52) U.S. Cl. CPC G06F 17/30684; G06F 17/30011; G06F 17/30707

(57) ABSTRACT

According to one embodiment, an apparatus for extracting keywords from a single document includes a key sentence extraction unit and a keyword extraction unit. The key sentence extraction unit extracts key sentences from the single document. The keyword extraction unit extracts keywords from the key sentences.

### CROSS-REFERENCE TO RELATED APPLICATION

This application is based upon and claims the benefit of priority from Chinese Patent Application No. 201510632825.X, filed on Sep. 29, 2015; the entire contents of which are incorporated herein by reference.

### FIELD

The present invention relate to an apparatus and a method for extracting keywords from a single document.

### BACKGROUND

Keyword extraction will be involved in field of natural language processing. Methods for keyword extraction may be roughly classified into two types, namely, supervised learning and unsupervised learning. In supervised learning, keyword extraction is deemed as a classification problem and training data needs to be labeled manually, which is time consuming and labor intensive, and is proved to be unsuitable in the Internet Era. With the development of science and technology and the increasing popularity of Internet, basically, supervised learning is seldom used.

As to unsupervised learning, mainly, there are three following algorithms in prior art;
(1) TF-IDF based and TF-IDF deformation based algorithms The mathematic formula is as follow:

$$Score ( ω ) = {TF}_{ω} * {log}_{2} \frac{{D}_{set}}{{DF}_{ω}} \qquad ( 1 )$$

Where ω denotes the keyword, TF_{ω} denotes the frequency of ω in the document set, Dₛₑₜ denotes the document number in document set, DF_{ω} denotes the document number which contains ω (non-patent literature 1).
(2) Chart based algorithm. The mathematic formula of most classic algorithm, TextRank, is as follow:

$$WS ( {V}_{i} ) = ( 1 - d ) + {d}^{*} {Σ}_{{V}_{j} ∈ In ( {V}_{i} )} \frac{{w}_{ji}}{{Σ}_{{V}_{k} ∈ Out ( {V}_{j} )} {w}_{jk}} WS ( {V}_{j} ) \qquad ( 2 )$$

Where WS(Vᵢ) denotes the score of Vᵢ , In(Vᵢ) denotes the in-degree of Vᵢ, Out(Vⱼ)denotes the out-degree of Vᵢ, wⱼᵢ denotes the weight of edge which is from ωⱼ to wᵢ, d denotes the damped coefficient (non-patent literature 2).
(3) Delimiter based algorithm.
Firstly, they use terms in a delimiter list to split the sentence into individual segments and get every candidate's score with an algorithm like LA (Link Analysis). Secondly, they get the final score of every candidate through the follow formula:

$$Score ( ω ) = {Σ}_{j} {TC ( ω )}_{j}^{A} * log \frac{{D}_{set}}{{DF}_{ω}} \qquad ( 3 )$$

Where Score(ω) denotes the final score of keyword candidates, TC(ω)ⱼ^{A} denotes the score of ω in document j, Dₛₑₜ denotes the document number in document set, DF_{ω} denotes the document number which contains ω(non-patent literature 3).

The TF-IDF in the above algorithm (1) is an abbreviation for “term frequency-inverse document frequency”, which is a statistical algorithm for evaluating importance degree of a term on a document set or a corpus. Importance of a term increases in proportion to number of times it appears in a document, but meanwhile, the importance decreases in inverse proportion to its coverage in the document set or the corpus, the coverage denotes coverage degree of a term in a document set or a corpus, that is, how many documents have this term appeared therein. Specifically, TF denotes frequency of a term in a document, and IDF denotes Inverse Document Frequency, which may be understood as, within a document set or a corpus, for a certain term, the less the number of documents containing that term, the larger the IDF for that term. Thus, for a term with high frequency of appearing in some specific document but with low coverage degree in the entire document set or corpus (e.g., appears in only one document and has not appeared in other documents), a TF-IDF having high weight may be produced by calculating a product of TF and IDF. Therefore, TF-IDF is capable of filtering out common terms and retaining keywords.

### BRIEF DESCRIPTION OF THE DRAWINGS

FIG. 1 is a flowchart of a method for extracting keywords from a single document according to one embodiment of the invention.

FIG. 2 is a flowchart of a method for extracting keywords from a single document according to another embodiment of the invention.

FIG. 3 is a detailed flowchart of the keyword re-sorting processing of the method for extracting keywords from a single document in the embodiment of FIG. 2 of the invention.

FIG. 4 is a detailed flowchart of the keyword extension processing of the method for extracting keywords from a single document in the embodiment of FIG. 2 of the invention.

FIG. 5 is a schematic block diagram of an apparatus for extracting keywords from a single document according to another embodiment of the invention.

FIG. 6 is a schematic block diagram of units used in extracting key sentences by the apparatus for extracting keywords from a single document according to another embodiment of the invention.

### DETAILED DESCRIPTION

According to one embodiment, an apparatus for extracting keywords from a single document includes a keyword sentence extraction unit and a keyword extraction unit. The key sentence extraction unit extracts key sentences from the single document. The keyword extraction unit extracts keywords from the key sentences.

Below, preferred embodiments of the invention will be described in detail with reference to drawings.

A Method for Extracting Keywords from a Single Document

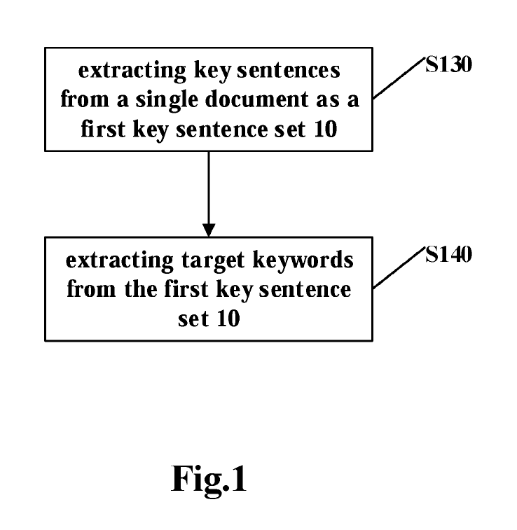

FIG. 1 is a flowchart of a method for extracting keywords from a single document according to one embodiment of the invention.

As shown in FIG. 1, first, in step S130, key sentences are extracted from the single document as a first key sentence set 10. In the present embodiment, the single document may be any type of document in any language, and the present embodiment has no limitation thereon.

Then, the method proceeds to step S140, target keywords are extracted from the first key sentence set 10.

According to the above method of the present embodiment, extraction quality for target keyword can be effectively improved by extracting key sentences from single document and then extracting keywords from the key sentences. Generally, probability of appearing in key sentence is much higher than that in non-key sentence. This is because candidate keywords are not extracted from all the sentences in the single document, rather, they are extracted from a key sentence set which is only a subset of all sentences in the document, so number of candidate keywords may be reduced, which means that probability that a target keyword is extracted has been increased, and extraction quality will also be significantly improved.

Here, as an example, assume there are 100 sentences in the single document, containing in total 1000 different words, in which there are 20 target keywords. If stop words are removed (assume that stop words account for 30% of total words), the remaining 700 words are all candidate keywords. The target keywords need to be selected from the 700 candidate keywords. If there are 40 key sentences in the document, containing in total 400 different words, after removing stop words, the remaining 280 words are candidate keywords. Probability of correctly selecting 20 target keywords from 280 candidate keywords is obvious larger than probability of correctly selecting 20 target keywords from 700 candidate keywords.

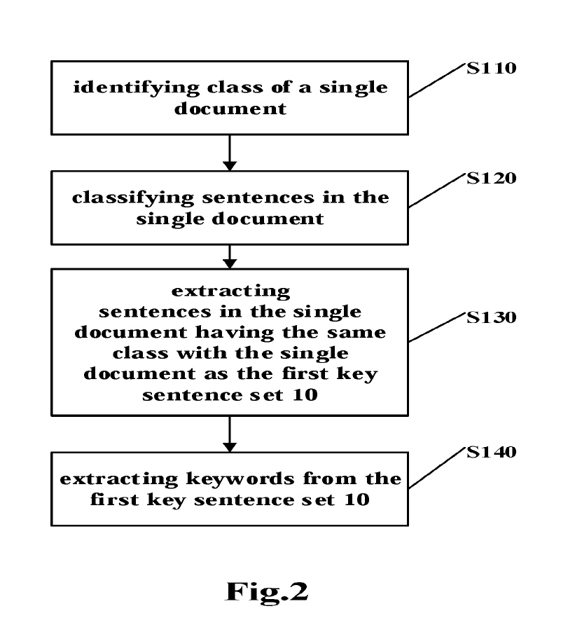

There is no special limitation on the method for extracting keywords from a single document. For example, before extracting key sentences, as shown in FIG. 2, the method may further comprise the following steps.

In step S110, class of the single document is identified. In the present embodiment, for example, a document classifier is used in advance to automatically assign a class label to the single document itself. The document classifier may be trained from a mature algorithm (SVM, NBM, VSM etc), or on-shelf tools offered by other scientific research institution or organization may be used, and the present embodiment has no limitation thereon.

Next, in step S120, sentences in the single document are classified. In the present embodiment, for example, a sentence classifier is used to automatically assign a class label to each sentence in the single document. The sentence classifier, like the document classifier, may be trained from a mature algorithm (SVM, NBM, VSM etc), or on-shelf tools offered by other scientific research institution or organization may be used, and the present embodiment has no limitation thereon.

On basis of S110 and S120, in step S130, sentences in the single document having the same class with the single document are extracted, in the present embodiment, since class label is used, sentences in the single document whose class label is the same as the class label of the single document are selected as the first key sentence set 10.

Where sentences in the single document having the same class with the single document are extracted as key sentences, the key sentences are capable of characterizing main meaning of that document, thus extraction quality for target keyword can be more effectively improved.

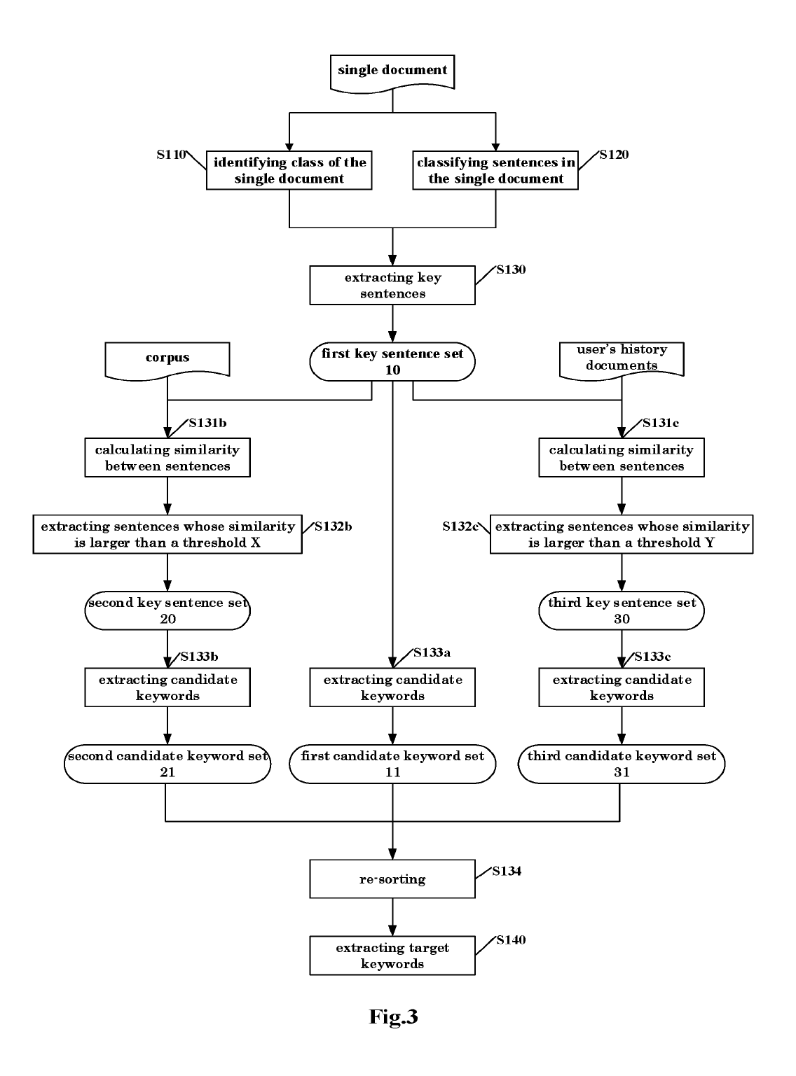

In the present embodiment, preferably, after extracting key sentences, keywords based on the first key sentence set 10 are re-sorted and then target keywords are extracted. Hereinafter, the description will be given with reference to FIG. 3.

As shown in FIG. 3, after step S130, first, in step S131b, the first key sentence set 10 is traversed, and similarity between each sentence in the corpus and sentence in the first key sentence set 10 is calculated through a sentence similarity algorithm (such as VSM). Likely, in step S131c, the first key sentence set 10 is traversed, and similarity between each sentence in user's history documents and sentence in the first key sentence set 10 is calculated through a sentence similarity algorithm (such as VSM).

Next, in step S132b, sentences whose calculated similarity is larger than a preset threshold X are extracted from the corpus as a second key sentence set 20. Likely, in step S132c, sentences whose calculated similarity is larger than a preset threshold Y are extracted from user's history documents as a third key sentence set 30. For X and Y, they may be set to be same or different as needed.

By pre-setting thresholds X and Y, sentences in a corpus and user's history documents similar to key sentences in a single document can be accurately filtered out as needed, which helps to improve extraction quality of target keywords.

Next, in step S133a, a corresponding weighted candidate keyword set, that is, a first candidate keyword set 11, is extracted from the first key sentence set 10 by using a common keyword extraction algorithm (such as TF-IDF, TextRank, Delimiter-Based, etc). Likely, in step S133b, a second corresponding weighted candidate keyword set 21 is extracted from the second key sentence set 20 by using a common keyword extraction algorithm (such as TF-IDF, TextRank, Delimiter-Based, etc). In step S133c, a third corresponding weighted candidate keyword set 31 is extracted from the third key sentence set 30 by using a common keyword extraction algorithm (such as TF-IDF, TextRank, Delimiter-Based, etc).

Next, in step S134, the first candidate keyword set 11 is re-sorted based on the second candidate keyword set 21 and the third candidate keyword set 31.

Next, the method proceeds to step S140, target keywords are extracted from the re-sorted first candidate keyword set 11.

In the following, the re-sorting method employed in step S134 will be described in detail by taking linear interpolation method for example.

First, weight α,β,γ are respectively assigned to the first candidate keyword set 11, the second candidate keyword set 21 and the third candidate keyword set 31. Let Score(ω in 11) denote weight of a candidate keyword in the first candidate keyword set 11, Score(ω in 21) denote weight of that candidate keyword in the second candidate keyword set 21, and Score(ω in 31) denote weight of that candidate keyword in the third candidate keyword set 31. Calculation is performed on each candidate keyword in the in the first candidate keyword set 11 based on the flowing formula (4):

Score(ω)=α*Score(ω in 11)+β*Score(ω in 21)+γ*Score(ω in 31) (4)

Thereafter, candidate keywords in the first candidate keyword set 11 are re-sorted based on the calculated comprehensive weight Score(ω).

Within a single document, content is limited and there is no sufficient information to assist in extracting target keywords. While in the present embodiment, by re-sorting keywords in the first candidate keyword set 11 based the second candidate keyword set 21 and the third candidate keyword set 31 as described above, and adjusting keywords in the single document with the help of information in a corpus or user's history documents that is related to the document, position of a target keyword in sorting can be relatively raised, and extraction quality of target keyword is further improved.

Furthermore, since re-sorting is conducted by using respective predetermined weight, information in a corpus or user's history documents can be more effectively utilized to accurately re-sort candidate keywords, thereby improving extraction quality of target keyword.

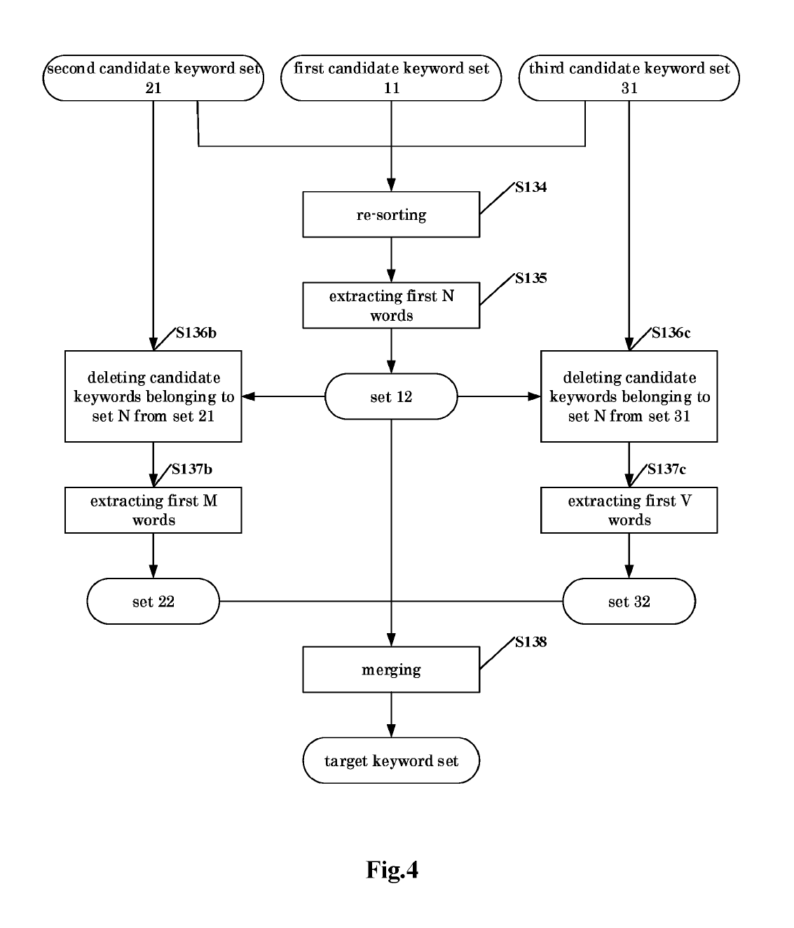

In the present embodiment, preferably, after conducting re-sorting, extension of keywords is performed. Hereinafter, the description will be given with reference to FIG. 4.

After re-sorting candidate keywords in the first candidate keyword set 11, that is, after S134, as shown in FIG. 4, in step S135, the first N candidate keywords are extracted from the first candidate keyword set 11 as set 12.

Next, in step S136b, candidate keywords contained in the set 12 extracted in step S135 are deleted from the second candidate keyword set 21. Likely, in step S136c, candidate keywords contained in the set 12 extracted in step S135 are deleted from the third candidate keyword set 31.

Next, in step S137b, the first M candidate keywords are extracted from the second candidate keyword set 21 onto which deletion has been performed as set 22. Likely, in step S137c, the first V candidate keywords are extracted from the third candidate keyword set 31 onto which deletion has been performed as set 32.

Next, in step S138, the sets 12, 22 and 32 are merged, thereby obtaining a final target keyword set.

In some cases, there are some keywords not existed in the single document but still highly related to content in the single document. Thus, in the present embodiment, in order to not omit the above keywords, preferably, keywords existed in a corpus or user's history documents and highly related to content in the single document are extracted, and along with keywords extracted from the single document, forms the final keyword set. By performing extension in such a manner, extraction quality for keywords can be significantly improved.

In the above embodiment, description is made by taking simultaneously using a corpus and user's history documents to perform keyword re-sorting and keyword extension for example, however, only one of a corpus and user's history documents may be used to perform keyword re-sorting and keyword extension.

Furthermore, order of the above steps is not fixed, for example, in the present embodiment, after identifying class of the single document (namely, S110), sentences in the single document are classified (namely, S120), but the invention is not limited thereto, it is also possible that, after classifying sentences in the single document, class of the single document is identified.

An Apparatus for Extracting Keywords from a Single Document

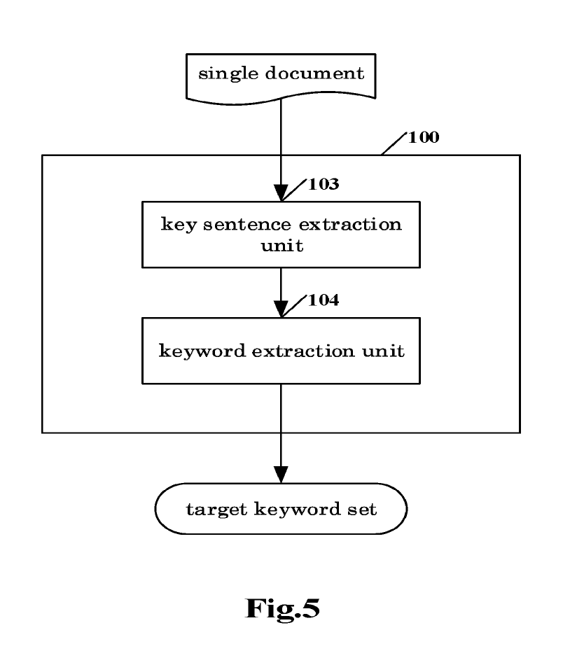

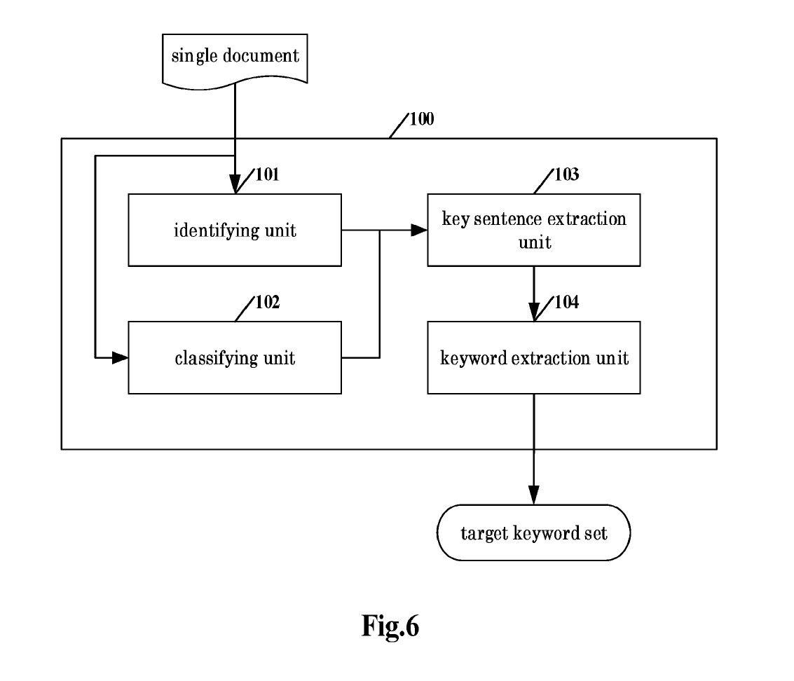

Under a same inventive concept, FIG. 5 and FIG. 6 are block diagrams of an apparatus for extracting keywords from a single document according to another two embodiments of the invention. Next, the present embodiment will be described in conjunction with that figure. For those same parts as the above embodiments, the description of which will be properly omitted.

As shown in FIG. 5, the apparatus for extracting keywords from a single document (referred to as “keyword extraction apparatus” hereinafter) 100 of the present embodiment comprising: a key sentence extraction unit 103 and a keyword extraction unit 104. The key sentence extraction unit 103 is configured to extract key sentences from the single document as a first key sentence set 10; and the keyword extraction unit 104 is configured to extract keywords from the first key sentence set 10.

According to the keyword extraction apparatus 100 of the present embodiment, extraction quality for target keyword can be effectively improved by extracting key sentences from single document and then extracting keywords from the key sentences. Generally, probability of appearing in key sentence is much higher than that in non-key sentence. This is because candidate keywords are not extracted from all the sentences in the single document, rather, they are extracted from a key sentence set which is only a subset of all sentences in the document, so number of candidate keywords may be reduced, which means that probability that a target keyword is extracted has been increased, and extraction quality will also be significantly improved.

Here, as an example, assume there are 100 sentences in the single document, containing in total 1000 different words, in which there are 20 target keywords. If stop words are removed (assume that stop words account for 30% of total words), the remaining 700 words are all candidate keywords. The target keywords need to be selected from the 700 candidate keywords. If there are 40 key sentences in the document, containing in total 400 different words, after removing stop words, the remaining 280 words are candidate keywords. Probability of correctly selecting 20 target keywords from 280 candidate keywords is obvious larger than probability of correctly selecting 20 target keywords from 700 candidate keywords.

Furthermore, the keyword extraction apparatus 100, as shown in FIG. 6, may also be provided with an identifying unit 101 and a classifying unit 102.

The identifying unit 101 is configured to identify class of the single document. In the present embodiment, for example, a document classifier is used in advance to automatically assign a class label to the single document itself. The document classifier may be trained from a mature algorithm (SVM, NBM, VSM etc), or on-shelf tools offered by other scientific research institution or organization may be used. There is no special limitation on the document classifier, as long as it can classify the single document.

The classifying unit 102 is configured to classify sentences in the single document. In the present embodiment, for example, the classifying unit 102 may be a sentence classifier that automatically assigns a class label to each sentence in the single document. The sentence classifier, like the document classifier, may be trained from a mature algorithm (SVM, NBM, VSM etc), or on-shelf tools offered by other scientific research institution or organization may be used. There is no special limitation on the sentence classifier, as long as it can classify each sentence in the single document.

The key sentence extraction unit 103 is configured to extract sentences in the single document having the same class with the single document as a first key sentence set 10 based on identification result of the identifying unit 101 and classification result of the classifying unit 102.

Where sentences in the single document having the same class with the single document are extracted as key sentences, the key sentences are capable of characterizing main meaning of that document, thus extraction quality for target keyword can be more effectively improved.

Furthermore, the keyword extraction apparatus 100 may also comprises a sorting unit 105 configured to re-sort keywords that are based on the first key sentence set 10.

First, the first key sentence set 10 is traversed by the key sentence extraction unit 103, and similarity between each sentence in the corpus and sentence in the first key sentence set 10 is calculated through a sentence similarity algorithm (such as VSM). Likely, the first key sentence set 10 is traversed by the key sentence extraction unit 103, and similarity between each sentence in user's history documents and sentence in the first key sentence set 10 is calculated through a sentence similarity algorithm (such as VSM).

Based on result of similarity, sentences whose calculated similarity is larger than a preset threshold X are extracted from the corpus as a second key sentence set 20. Likely, sentences whose calculated similarity is larger than a preset threshold Y are extracted from user's history documents as a third key sentence set 30. For X and Y, they may be set to be same or different as needed.

By pre-setting thresholds X and Y, sentences in a corpus and user's history documents similar to key sentences in a single document can be accurately filtered out as needed, which helps to improve extraction quality of target keywords.

Next, the keyword extraction unit 104 extracts a corresponding weighted candidate keyword set, that is, a first candidate keyword set 11, from the first key sentence set 10 by using a common keyword extraction algorithm (such as TF-IDF, TextRank, Delimiter-Based, etc), likely, extracts a second corresponding weighted candidate keyword set 21 from the second key sentence set 20 by using a common keyword extraction algorithm (such as TF-IDF, TextRank, Delimiter-Based, etc), and extracts a third corresponding weighted candidate keyword set 31 from the third key sentence set 30 by using a common keyword extraction algorithm (such as TF-IDF, TextRank, Delimiter-Based, etc).

Next, the sorting unit 105 is configured to re-sort the first candidate keyword set 11 based on the second candidate keyword set 21 and the third candidate keyword set 31 extracted by the keyword extraction unit 104.

Next, the keyword extraction unit 104 is configured to extract target keywords from the re-sorted first candidate keyword set 11.

In the following, the re-sorting method employed by the sorting unit 105 will be described in detail by taking linear interpolation method for example.

First, weight α,β,γ are respectively assigned to the first candidate keyword set 11, the second candidate keyword set 21 and the third candidate keyword set 31. Let Score(ω in 11) denote weight of a candidate keyword in the first candidate keyword set 11, Score(ω in 21) denote weight of that candidate keyword in the second candidate keyword set 21, and Score(ω in 31) denote weight of that candidate keyword in the third candidate keyword set 31. Calculation is performed on each candidate keyword in the in the first candidate keyword set 11 based on the flowing formula (4):

Score(ω)=α*Score(ω in 11)+β*Score(ω in 21)+γ*Score(ω in 31) (4)

Thereafter, candidate keywords in the first candidate keyword set 11 are re-sorted based on the calculated comprehensive weight Score(ω).

Within a single document, content is limited and there is no sufficient information to assist in extracting target keywords. While in the present embodiment, by re-sorting keywords in the first candidate keyword set 11 based the second candidate keyword set 21 and the third candidate keyword set 31 as described above, and adjusting keywords in the single document with the help of information in a corpus or user's history documents that is related to the document, position of a target keyword in sorting can be relatively raised, and extraction quality of target keyword is further improved.

Furthermore, since re-sorting is conducted by using respective predetermined weight, information in a corpus or user's history documents can be more effectively utilized to accurately re-sort candidate keywords, thereby improving extraction quality of target keyword.

The keyword extraction unit 104 is configured to preferably perform extension of keywords after conducting re-sorting. Specifically, the keyword extraction unit 104 is configured to extract the first N candidate keywords from the first candidate keyword set 11 as set 12, and to delete keywords contained in the set 12 from the second candidate keyword set 21 and the third candidate keyword set 31 respectively, further, to extract the first M candidate keywords from the second candidate keyword set 21 onto which deletion has been performed as set 22, likely, to extract the first V candidate keywords from the third candidate keyword set 31 onto which deletion has been performed as set 32, and to merge the sets 12, 22 and 32, thereby obtaining a final target keyword set.

In some cases, there are some keywords not existed in the single document but still highly related to content in the single document. Thus, in the present embodiment, in order to not omit the above keywords, preferably, keywords existed in a corpus or user's history documents and highly related to content in the single document are extracted, and along with keywords extracted from the single document, forms the final keyword set. By performing extension in such a manner, extraction quality for keywords can be significantly improved.

In the above embodiment, description is made by taking simultaneously using a corpus and user's history documents to perform keyword re-sorting and keyword extension for example, however, only one of a corpus and user's history documents may be used to perform keyword re-sorting and keyword extension.

The above apparatus and method for extracting keywords from a single document of the present invention are applicable to various fields of natural language processing, such as machine translation, text summarization, etc, and the invention has no limitation thereon.

Although an apparatus and method for extracting keywords from a single document of the present invention have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

1. An apparatus for extracting keywords from a single document, comprising:
a key sentence extraction unit that extracts key sentences from the single document; and
a keyword extraction unit that extracts keywords from the key sentences.

2. The apparatus for extracting keywords from a single document according to claim 1, further comprising:
an identifying unit that identifies class of the single document; and
a classifying unit that classifies sentences in the single document;
the key sentence extraction unit extracts the key sentences in the single document having the same class with the single document as a first key sentence set,
the keyword extraction unit extracts the keywords from the first key sentence set.

3. The apparatus for extracting keywords from a single document according to claim 2, wherein,
the keyword extraction unit extracts a first keyword set from the first key sentence set,
the key sentence extraction unit extracts, from a corpus, sentences similar to key sentences in the first key sentence set as a second key sentence set,
the keyword extraction unit extracts a second keyword set from the second key sentence set,
the apparatus further comprises a sorting unit that re-sorts keywords in the first keyword set based on the second keyword set,
the keyword extraction unit that extracts keywords from the re-sorted first keyword set.

4. The apparatus for extracting keywords from a single document according to claim 3, wherein,
the sorting unit calculates weight of keywords based on weight of the first keyword set, weight of the keywords in the first keyword set, weight of the second keyword set and weight of the keywords in the second keyword set, and re-sorts the first keyword set based on the calculated weight.

5. The apparatus for extracting keywords from a single document according to claim 3, wherein,
the keyword extraction unit deletes, from the second keyword set, keywords extracted from the first keyword set, and extracts keywords from the second keyword set onto which deletion has been performed.

6. The apparatus for extracting keywords from a single document according to claim 1, wherein,
the keyword extraction unit extracts a first keyword set from the first key sentence set,
the key sentence extraction unit extracts, from user's history documents, sentences similar to key sentences in the first key sentence set as a third key sentence set,
the keyword extraction unit extracts a third keyword set from the third key sentence set,
the apparatus further comprises a sorting unit that re-sorts keywords in the first keyword set based on the third keyword set,
the keyword extraction unit extracts keywords from the re-sorted first keyword set.

7. The apparatus for extracting keywords from a single document according to claim 6, wherein,
the key sentence extraction unit
calculates similarity between sentences in the corpus and the key sentences, and extracts sentences from the corpus whose similarity is larger than a preset first threshold as sentences similar to the key sentences,
calculates similarity between sentences in the user's history documents and the key sentences, and extracts sentences from the user's history documents whose similarity is larger than a preset second threshold as sentences similar to the key sentences.

8. The apparatus for extracting keywords from a single document according to claim 6, wherein,
the sorting unit calculates weight of keywords based on weight of the first keyword set, weight of the keywords in the first keyword set, weight of the third keyword set and weight of the keywords in the third keyword set, and re-sorts the first keyword set based on the calculated weight.

9. The apparatus for extracting keywords from a single document according to claim 6, wherein,
the keyword extraction unit deletes, from the third keyword set, keywords extracted from the first keyword set, and extracts keywords from the third keyword set onto which deletion has been performed.

10. A method for extracting keywords from a single document, comprising:
extracting key sentences from the single document; and
extracting keywords from the key sentences.
